(19) United States
(12) Patent Application Publication
(10) Pub. No.: US 2016/0219199 A1
(43) Pub. Date: Jul. 28, 2016

(54) Reflective Selfie Device

(71) Applicants: Gary Streuter, Laguna Niguel, CA (US); William Pat Price, Henderson, NV (US)

(72) Inventors: Gary Streuter, Laguna Niguel, CA (US); William Pat Price, Henderson, NV (US)

(21) Appl. No.: 15/004,992

(22) Filed: Jan. 24, 2016

Related U.S. Application Data
(60) Provisional application No. 62/107,097, filed on Jan. 23, 2015.

(51) Int. Cl. H04N 5/225; H04M 1/02

(52) U.S. Cl. CPC H04N 5/2254; H04M 1/0264; H04M 1/0266; H04M 1/0283

(57) ABSTRACT

TEmbedding of, or attachment to the rear surface of a mobile electronic device of a reflective panel that allows the user of the mobile device to obtain a general reflection of the image that would be photographed by the rear facing camera on the mobile device without the benefit of seeing the image presentation that is displayed on the opposite side viewing screen of the electronic device

This application claims priority from provisional 62107097, filed Jan. 23, 2015, the entire contents of which are herewith incorporated by reference.

### FIELD OF INVENTION

The field of invention relates to mobile electronic devices that have an embedded camera on the opposite surface of the display screen on the electronic device.

### BACKGROUND

WE LOVE SELFIES . . . One of the most popular uses of cameras on mobile devices today is the taking of “Selfies”. A Selfie is a photograph or video taken by the person who actually takes the picture of themselves alone, or in a group of other people. A Selfie includes the initiator of the photo or video—and is thus referred to as a Selfie. By definition a Selfie is a self-portrait photograph, typically taken with a hand-held smart phone or tablet. Many mobile devices today have at least one camera embedded within the device and what is usually known as a face or front-facing camera on the same surface of the device as the integrated display screen. Thus when a Selfie is being taken, the initiator can preview on the display screen the image that will be taken and make adjustments as necessary to change the image preview.

However, many smart phones and tablets available today also include another camera mechanism that is mounted on the rear surface of the device and on the opposite side as the display screen of the device. These back-facing camera's can be used like a traditional camera where the back-facing camera is pointed at the object to be photographed while the image is reviewed by the user in the display screen on the opposite side of the device.

In a great many instances, the capabilities of these back-facing cameras far exceed those of the front-facing camera. This can be explained by the difference in cost of the higher capability camera but also by the main use of the front facing camera being functions like video chatting or Skype.

Thus, Selfies taken today typically use the lower capability front-facing camera and thus the image and/or video taken in the Selfie is a lower quality than what could be obtained by using the higher capability back-facing camera.

So why not simply turn the camera around and use the back-facing camera for my Selfie? The answer lies in the fact that because if this is done, the display screen is not in view and thus the user has no idea what exactly they are taking a picture of—because they cannot see the screen.

The objective of the present invention is to provide an easy to use method of allowing users to shoot Selfies using the back-facing camera on their mobile device and to have a general idea of the picture that is being framed in the device.

This is accomplished by adding a reflective panel to the rear surface of the mobile device. This reflective panel can be seen by the user when they have rotated the mobile device to use the back-facing camera on their device. While the reflective panel does not give an exact representation of what is framed in the display screen, it does serve as a good indicator of what the back-facing camera is seeing and allows the user to make angle adjustments based on the reflection shown in the reflective panel.

This reflective panel does not need to be of any specific size or shape. It may consist of a mirrored finish type panel, or perhaps highly polished metal or foil. The object of the panel is to simply provide a general idea of what will be captured in the photo or video.

The reflective panel could be embedded within the construction of the non-display surface of the mobile device, or it could be a simple add on with adhesive or an extension arm.

The use of the higher capability back-facing camera can greatly improve the user experience and the use of this invention dramatically increases the chances that the user will get an image or video they are satisfied with.

This disclosure defines a system and method that supports this user convenience.

### PROBLEM STATEMENT

What is needed is an apparatus and system of improving the ability of a user to use a higher capacity back-facing camera on a mobile device to effectively take what are known as Selfie photos and video.

### SUMMARY

The shortcomings of relying on the current system of using the lower resolution front-facing camera for Selfies is remedied by the addition of the reflective panel described in this disclosure to the rear panel of the mobile device, thus allowing the higher capability back-facing camera to be used for Selfies with a higher degree of user satisfaction.

An embodiment describes A reflective panel physically embedded within, or attached to a mobile electronic device such as a smart phone or tablet and positioned adjacent to a camera lens such that when viewed will approximate the viewers likeness that would appear on a picture taken by the camera.

### EMBODIMENTS

Reference will now be made in detail to various embodiments, examples of which are illustrated in the accompanying drawings. Wherever possible, the same reference numbers will be used throughout the drawings to refer to the same or like parts.

### DEFINITIONS

Selfie: A self-portrait photograph, typically taken with a hand-held smart phone, PDA, or tablet.
Mobile Electronic Device: Typically a smart phone, PDA, or tablet with photographic capabilities.
Front-Facing Camera—A camera device embedded within a mobile electronic device in the same plane and surface as the display screen of the mobile electronic device.
Back-Facing Camera: A camera device embedded with a mobile electronic device in the opposite plane and surface as the display screen of the mobile electronic device.

### BRIEF DESCRIPTION OF THE DRAWINGS

FIG. 1 is a depiction of the apparatus of the invention where three views of a cellular phone with a rear facing camera is depicted in a back view, a side view, and a front view.

FIG. 2 is a depiction of the apparatus of the invention where a back view of a cellular phone with a rear facing camera is depicted with a square mirror or reflective surface.

FIG. 3 is a depiction of the apparatus of the invention where three views of a cellular phone with a rear facing camera is depicted in a back view, a side view, and a front view contained within a cover for the cellular phone.

FIG. 4 is a depiction of the reflective devices attached to the back of the cellular phone.

FIG. 5 is a depiction of George Washington taking a “selfie” with the back facing camera where the image of the person taking the selfie is displayed on the display screen.

FIG. 6 is a depiction of George Washington taking a selfie where he used the back facing camera and guessed where his image would be placed on the display screen.

FIG. 7 is a depiction of George Washington taking a selfie utilizing the invention where he centers the reflection of his face in the reflective mirror on the back of the cellular phone which ensures that his image on the display screen is properly placed.

FIG. 8 is a depiction of a mounting system where the reflective surface is mechanically fixed to the back surface of the cellular phone or to the back surface cover of the cellular phone.

FIG. 9 is a depiction of a mounting system where the reflective surface is fixed to the back surface of the cellular phone or to the back surface cover of the cellular phone through use of a adhesive pad or adhesive applied to the back surface of the reflective surface.

### DETAILED DESCRIPTION OF THE INVENTION

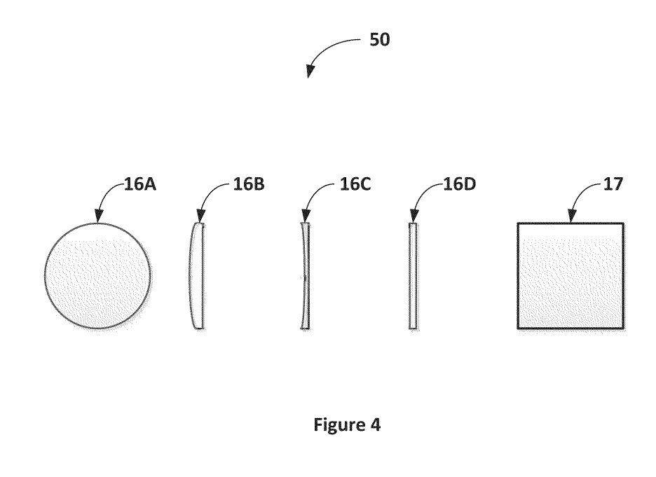

Now referencing FIG. 4 of the invention. In this depiction 50 shows five possible reflecting devices. These are a round mirror 16A with a flat surface profile. Round mirror 16A may also have any of the surface profiles shown as 16B (convex), 16C (concave), and 16D (flat). The shape of the reflective device may be any shape such as round 16A-16D, or square shown as 17.

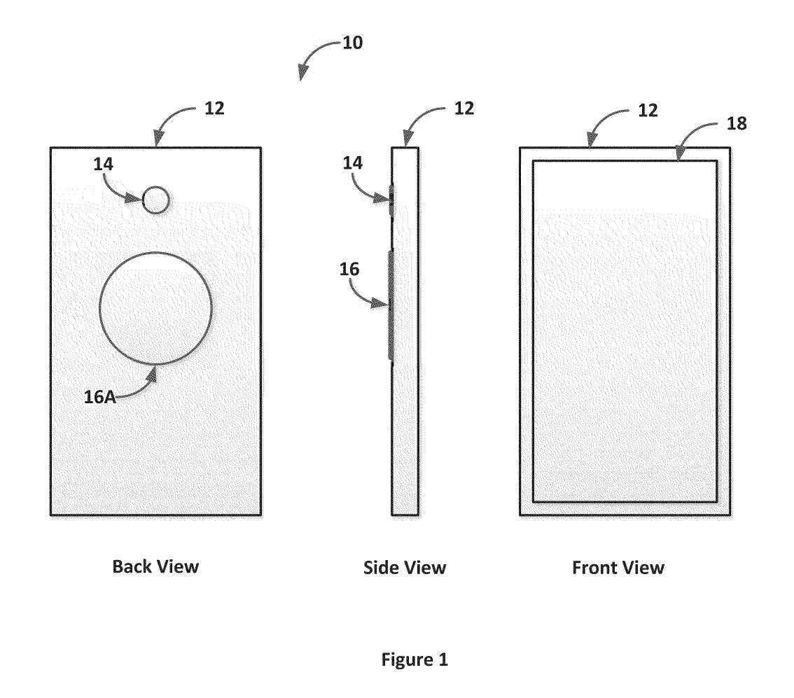

Now referencing FIG. 1 where 10 depicts a cellular phone with a back, side, and front view. In the back view, 12 is the back of the cellular phone with 14 depicting the rear facing camera lens and 16A depicting the reflective surface such as a round mirror. The side view depicted in FIG. 1 shows a side view of cellular phone 12 with rear facing camera lens 14 and rear facing reflective surface 16A. The front view depicts cellular phone 12 with display screen 18.

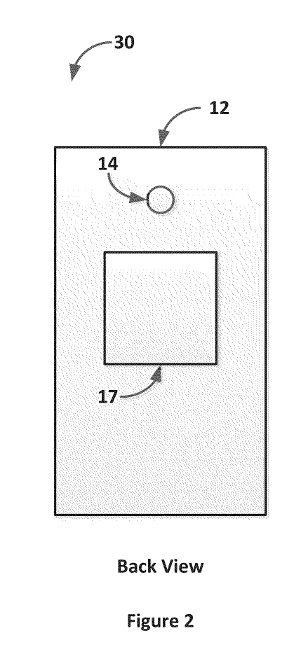

Now referencing FIG. 2 where 20 depicts a back view of cellular phone 12 with rear facing camera lens 14 and reflective surface 17 which is square in shape as opposed to round reflective surface 16A depicted in FIG. 1.

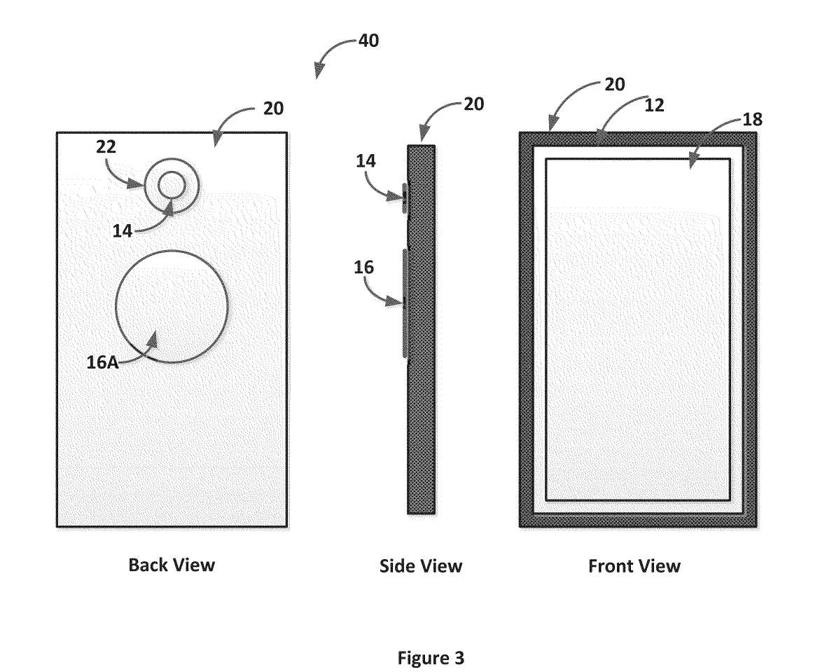

Now referencing FIG. 3 where 30 depicts cellular phone 12 with a cover 20. In this depiction, back view shows a hole in through the back of cover 20 where camera lens 14 has a clear unobstructed view and reflective surface 16A is mounted on the back side of cover 20 adjacent to rear facing camera lens 14. Side view of cellular phone 12 with cover 20 shows where reflective surface 16A is mounted to and projects outward from the back of cover 20. The side view also shows rear facing camera lens 14 protruding slightly through and protruding outward through the back of cover 20. Note that not all rear facing camera lens protrude outward from the body of cellular phone 12 and some lens are slightly under the surface plane of the back of cellular phone 12. Front view of cellular phone 12 shows the perimeter of cover 20 with display screen 18 being unobstructed by cover 20.

Now referencing FIG. 4 where 50 depicts different configurations of round reflective surface 16A. In this depiction, the surface of 16A may be convex as depicted by 16B, or it may be concave as depicted by 16C, or it may be flat as depicted by 16D. Round reflective surface 16 may also be any shape as depicted by 17 which is square. The reflective surface may also be rectangular or any other shape.

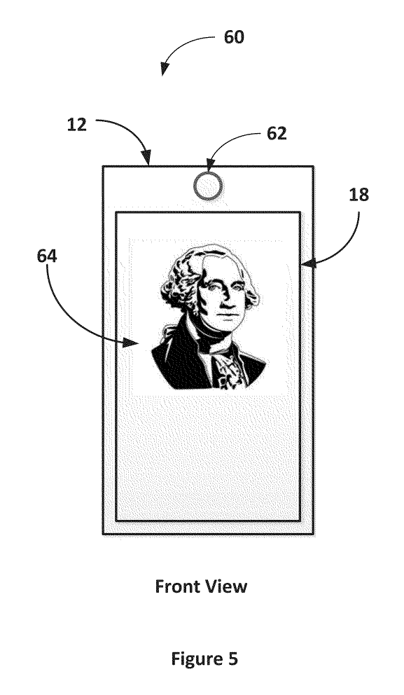

Now referencing FIG. 5 where 60 depicts a “selfie” of George Washington. In this depiction, George took the selfie of himself using front facing camera 62 of cellular phone 12. Note that George centered his image 64 on display screen 18 before pressing the shutter button (not shown). Ensuring that an image is centered on display 18 using the front facing camera 62 is relatively easy because the image being photographed is displayed in real time on display 18.

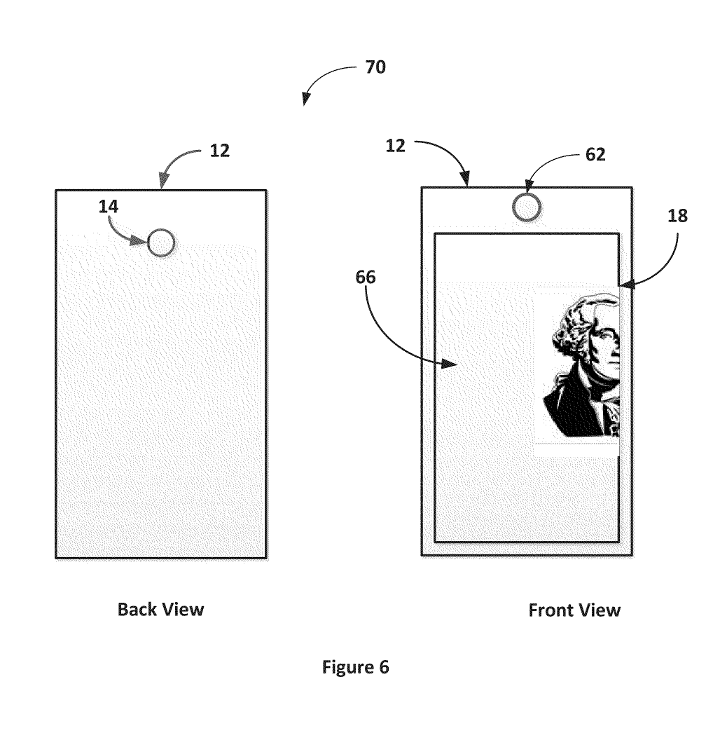

Now referencing FIG. 6 where 70 depicts another selfie of George Washington. In this depiction, George attempted to take a selfie using the rear facing camera lens 14. Note that George's image 66 on display screen 18 is off-center and in fact half of George's face is missing. This effect is quite common when a selfie is taken with a back facing camera because the user cannot see his image and can only guess where his image is in relation to the center of display screen 18.

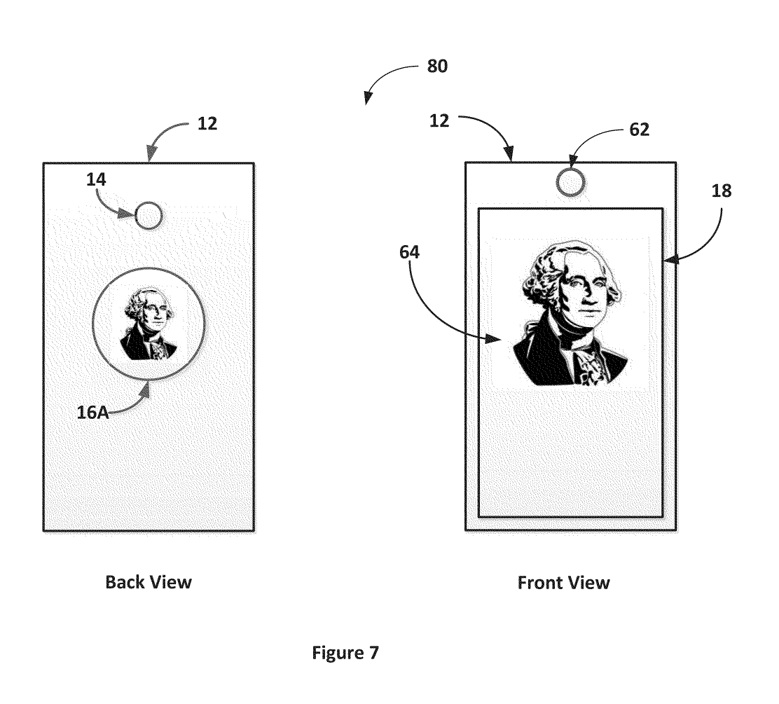

Now referencing FIG. 7 where 80 depicts another selfie of George Washington. In this depiction George is using cellular phone camera 12 where the invention is in place on the back facing surface of cellular phone camera 12. In this depiction, George has centered his image in the center of rear facing reflective surface 16A. Even though George cannot view his image in real time, the image as depicted on front facing display screen 18 is centered because of the close proximity of rear facing reflective surface 16A and rear facing camera lens 14.

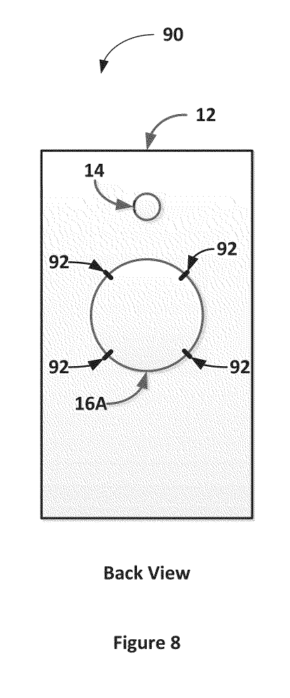

Now referencing FIG. 8 where 90 depicts a rear view of cellular phone 12 with reflective surface 16A fixed to the rear facing surface of cellular phone 12 through the use of mechanical fixtures 92 which may be staples, wires, or other such devices designed to capture reflective surface 16A such that it is held to the back surface of cellular phone 12 and prevented from moving.

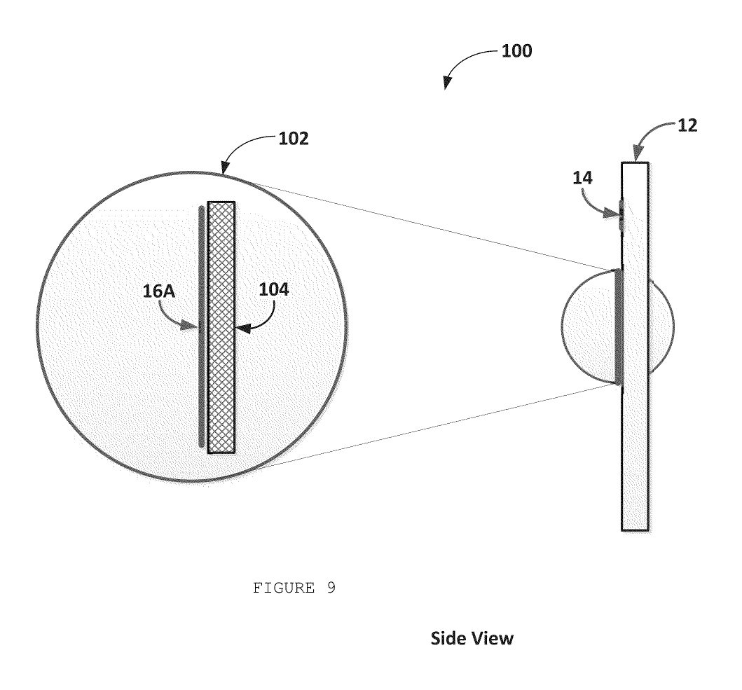

Now referencing FIG. 9 where 100 depicts a side view of cellular phone 12 with reflective surface 16A fixed to the rear facing surface of cellular phone 12. Note that in this depiction, 102 represents a magnified view of reflective surface 16A being fixed to adhesive pad 104 which in turn is fixed to the rear facing surface of cellular phone 12.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other *****.

Those of skill would further appreciate that the various illustrative logical blocks, modules, circuits, and algorithm steps described in connection with the embodiments disclosed herein may be implemented as electronic hardware such as special designed chips, computer software running on a programmed computer, that is programmed to carry out the operations described in this application, or combinations of both.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

The computer may include a microprocessor, that is part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Functions can also be carried out by programmed computer readable media which can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A system comprising:
a mobile electronic device;
a display screen on said mobile electronic device, a camera within said mobile electronic device whereby said camera is embedded in a plane and surface of the mobile electronic device that is oppositely facing relative to said display screen embedded within said mobile electronic device, and
a reflective panel that is embedded within, or attached to, the plane and surface of said mobile electronic device that is opposite the surface of said display screen embedded with the mobile electronic device.

2. The apparatus of claim 1 whereby said reflective panel embedded or attached to said surface of said mobile electronic device that is opposite of said display screen is one of to square, rectangular, oval and round.

3. The apparatus of claim 1 whereby said reflective panel embedded or attached to said surface of said mobile electronic device that is opposite of said devices display screen is fabricated from a material that provides a reflective surface capable of being viewed by ae user of said mobile electronic device.

4. The apparatus of claim 1 whereby said reflective panel is a flat surface.

5. The apparatus of claim 1 whereby said reflective panel is a convex surface.

6. The apparatus of claim 1 whereby said reflective panel is a concave surface.

7. The apparatus of claim 1 whereby said reflective panel is attached directly to the surface of said mobile electronic device.

8. The apparatus of claim 1 whereby said reflective panel is attached to the surface of the mobile electronic device using an adhesive compound.

9. The apparatus of claim 1 where said reflective panel may be attached to the surface of the mobile electronic device by a mechanical means.

10. The apparatus of claim 1 whereby said reflective panel may be attached to an external cover that encases the surface of mobile the electronic device.
